(19) United States
(12) Patent Application Publication
(10) Pub. No.: US 2005/0077302 A1
(43) Pub. Date: Apr. 14, 2005

(54) Spilless Caddy

(76) Inventor: David M. Kulp SR., Bethlehem, PA (US)

Correspondence Address: John Shaw Stevenson, 879 Crestline Drive, Blue Bell, PA, 19422, US

(21) Appl. No.: 10/682,821

(22) Filed: Oct. 10, 2003

(51) Int. Cl. B05C 21/00

(52) U.S. Cl. 220/574

(57) ABSTRACT

A spilless caddy having a carved lip that forms an opening in its upper top surface. The caddy is also provided with thumb gripping surfaces formed on an indented portion of the lip and finger gripping surfaces formed on a bottom portion of the caddy located between two spaced apart ridges. When these gripping surfaces are engaged by the thumb and finger of the user, it provides a way in which the caddy can be held in a rigid position in the hand of the user.

### BACKGROUND OF THE INVENTION

1. Description of Prior Art

Prior to the present invention it has been the practice of painters to grasp the wire loop attached to a paint can to support the can and the paint therein when he needs to paint. When a painter is painting windows and high portions of a wall near a ceiling, he generally employs a brush in one hand and supports the wire handle of a paint can in the other hand. While he is moving along from one painting area to another and periodically dipping his brush into the paint, the hand that holds the wire handle often has a tendency to stoop, twist or turn which causes spillage of paint from the can. This occurs particularly when he is dipping his brush into the can when the paint therein is nearly empty.

The purpose of the present invention is to provide an improved construction for the aforementioned paint can or any other similar caddy. The caddy disclosed herein is so constructed that any of the aforementioned movements of the painter's hand will not cause spillage of paint from such a caddy.

### SUMMARY OF THE INVENTION

It is an object of the invention to provide a caddy that will prevent a liquid; e.g., paint contained therein from spilling out of the caddy during a painting or any other similar operation.

It is another object of the present invention to provide a caddy that has an inverted semicircular lip that forms an open top portion of the caddy. This lip contains an indented retaining portion against which a left or right handed person's thumb can be engaged.

It is another object of the invention to provide at the closed bottom end of the caddy a portion that fits into the palm of the user's hand and has raised portions extending therefrom between which the user's fingers can be engaged to retain the caddy in a fixed immovable position in the hand after downward pressure of the aforementioned thumb has simultaneously taken place.

It is still another object of the invention to provide a gripping means for a caddy in which the aforementioned thumb applies a downward force to the top lip of the caddy while the aforementioned fingers between the raised portion at the bottom of the caddy apply an upward force so that the caddy is retained in an immovable position with respect to the user's hand.

It is another object that because of the aforementioned lip, thumb and finger gripping portions of this caddy, the arm of the user of this caddy can be tilted, bent or twisted in any direction and still prevent the loss of any paint from leaving the caddy.

### BRIEF DESCRIPTION OF THE DRAWINGS

FIG. 1 is a top view of the caddy showing a plurality of raised portions against which a right or left handed person's thumb is shown in retaining engagement therewith.

FIG. 2 is a section taken through section 2-2 of FIG. 1.

FIG. 2a is a view showing in detail form the plurality of raised thumb engaging ridges on the indented portion of the lip shown in FIGS. 1 & 2.

FIG. 2b is a view showing in detail form the plurality of raised finger engaging ridges shown in FIG. 2.

FIG. 3 is a front view of the caddy;

FIG. 4 is a left side view of the caddy that is shown in FIG. 3 and

FIG. 5 is a bottom view of the caddy showing how the fingers of a person that support and retain the caddy are positioned.

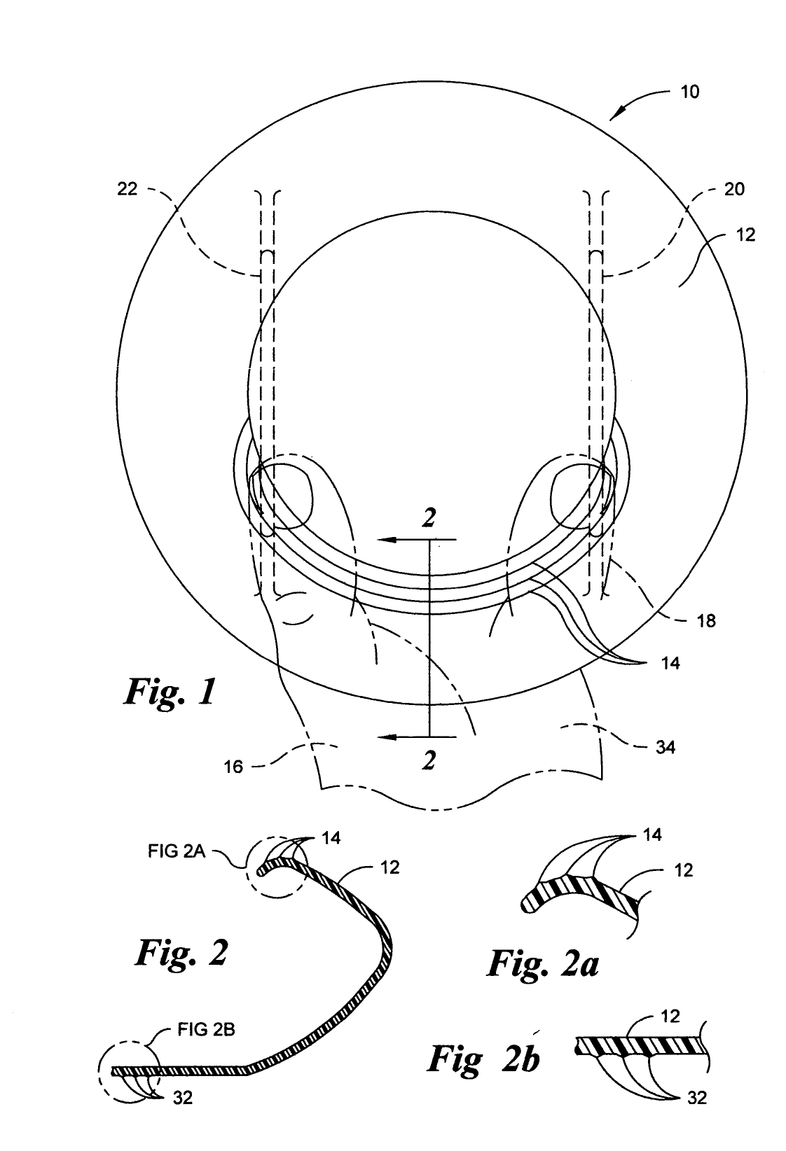

### DETAILED DESCRIPTION OF THE INVENTION

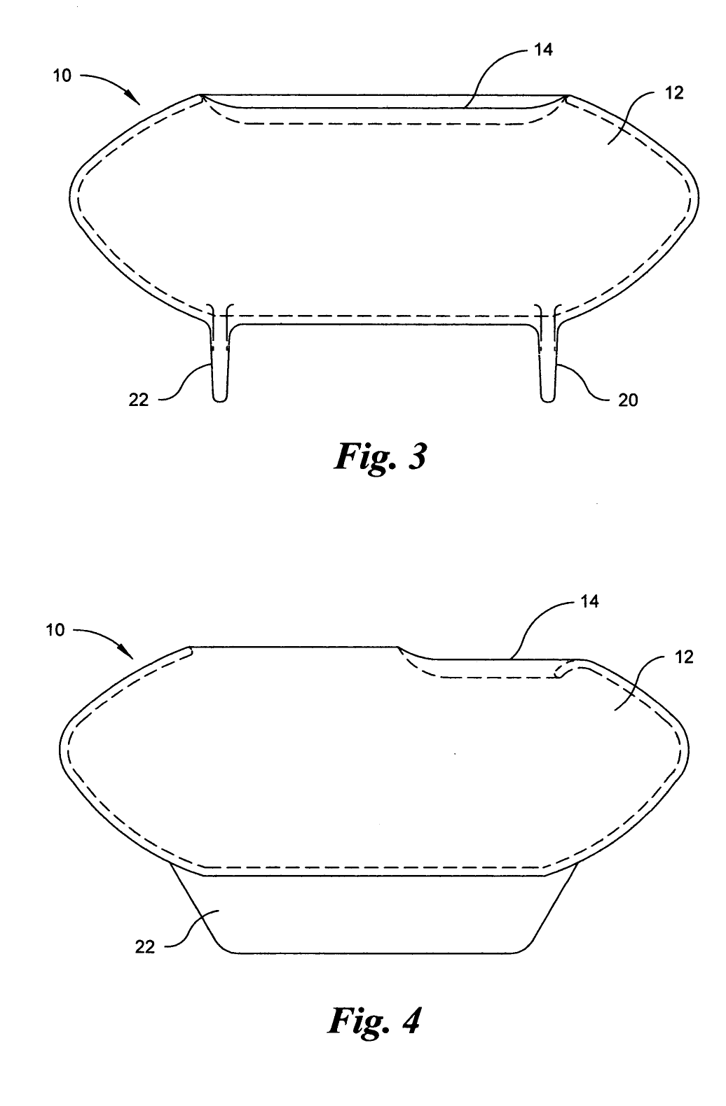

The top view of the caddy 10 shown in FIG. 1 of the drawings has an annular lip portion 12 that forms an open top end of the caddy. FIGS. 1, 3, 4 show this lip portion 12 having indented ridge portions 14 against which either a thumb 16, 18 of a right or left handed person is shown engaged, as is best shown in FIG. 1.

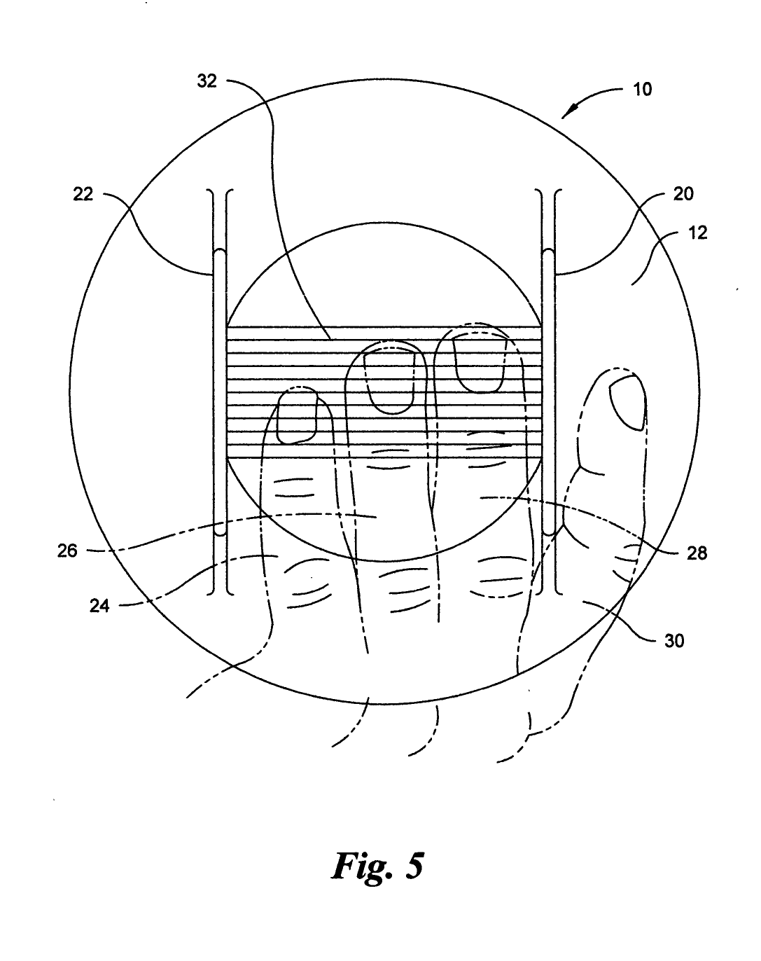

FIGS. 1, 5 also show two raised portions 20, 22 between which the user's fingers 24, 26, 28, which may be of different sizes, can be engaged as best shown in FIG. 5. FIG. 5 also shows another of the user's fingers 30 that is also shown in engagement with the bottom of the caddy 10. FIG. 5 also shows a series of ridges 32 against which the finger 24, 26, 28 can be fixedly engaged to force the caddy 10 along with finger 30 in an upward direction while a downward force of either a right or left hander's thumb 16 or 18 shown in FIG. 1 is applied. These opposing forces of the fingers 24, 26, 28, 30 and thumb 16 or 18 keep the caddy in an immovable position with the palm of the hand 34 as shown in FIGS. 1 and 5.

It can thus be seen from the aforementioned caddy construction 10 that any one employing such a caddy 10 can benefit from the use of this spilless caddy. For example, a painter can stoop, twist, turn or jump off a ladder during a brush painting operation and paint will be prevented from spilling out of the caddy. This is possible because the caddy will always be ridgedly held in his hand by the opposing forces that are applied to the bottom of the caddy 10 by his fingers 24, 26, 28 and 30 by either a right or left hander's thumb 16 or 18.

1. A spilless caddy to retain liquid therein, said caddy having a curved lip forming an opening in a top surface thereof, finger gripping surfaces formed on the bottom and lip surfaces of the caddy to retain it in a fixed position in the hand of a user.

2. The construction of the caddy as defined in claim 1 comprising a plurality of ridges extending across said bottom surface of the caddy to form said bottom gripping surface against which said fingers of a user can be engaged.

3. The construction of the caddy as defined in claim 1 comprising a plurality of ridges extending along an indented portion of said lip of the caddy to form said lip gripping surfaces against which the thumb of a user can be engaged.

4. The construction of the caddy as defined in claim 1 wherein the lip has an indented surface portion extending between opposite sides of the caddy to provide a surface against which the thumb of either a right or left handed person can be engaged.

5. The construction of the caddy as defined in claim 1 wherein the caddy has raised portions extended downwardly and away from the base and wherein the raised portions are spaced at a sufficient distance from one another in order to accommodate insertion of different sized fingers against the bottom gripping surfaces of said caddy.

6. The construction of the caddy as defined in claim 1 wherein the bottom surfaces of the caddy has spaced apart raised portions extending downwardly therefrom and wherein on of said raised portions is in alignment with one end of the lip that forms an opening in the top of the caddy and the other raised portion is in alignment with an opposite end of said lip that forms said opening in the top of the caddy.

7. The construction of the caddy as defined in claim 1 wherein the lip surface portion has a plurality of ridges protruding therefrom.

8. The construction of the caddy as defined in claim 1 wherein the bottom surface of the caddy has two spaced apart raised portions protruding downwardly therefrom and a plurality of spaced apart ridges extending between said raised portions against which the fingers of a user can be engaged.

9. The construction of the caddy in claim 1 wherein its lip surface has a plurality of spaced apart concave ridges forming said finger gripping surfaces thereon.

10. A caddy construction to prevent a liquid contained therein from exiting from its open end when a hand of a user that is holding the caddy is moved, comprising an inverted semicircular lip extending in a downward direction to form a top open end of the caddy, said lip having an indented surface portion against which a force of a thumb of a person using the caddy can be engaged in a downward direction, said caddy further having an annular curved side surface portion against which the palm of said user can be engaged, and spaced apart raised portions extending downwardly away from the base of the caddy between which fingers of a user can apply a force in an upward direction to retain the caddy in a fixed position in the palm of the user's hand.
